(19) United States
(12) Patent Application Publication
(10) Pub. No.: US 2025/0279446 A1
(43) Pub. Date: Sep. 4, 2025

(54) METHOD FOR IMPLEMENTING AN AMMONIA-FUELLED FUEL CELL WITH DIHYDROGEN RECYCLING, AND ASSOCIATED PLANT

(71) Applicant: TECHNIP ENERGIES FRANCE, Nanterre Cedex (FR)

(72) Inventors: Alice BAHA, NANTERRE CEDEX (FR); Thibault DE SORBIER, NANTERRE CEDEX (FR); Marc SELLINI, NANTERRE CEDEX (FR)

(21) Appl. No.: 18/862,363

(22) PCT Filed: May 4, 2023
(86) PCT No.: PCT/EP2023/061853

§ 371 Date: Nov. 1, 2024

(30) Foreign Application Priority Data
May 6, 2022 (FR) FR2204321

(51) Int. Cl. H01M 8/04089; H01M 8/04014; H01M 8/04119

(52) U.S. Cl. CPC H01M 8/04097; H01M 8/04014; H01M 8/04164; H01M 2250/10

(57) ABSTRACT

A method for implementing an ammonia-burning fuel-cell system, which comprises: a) operating a fuel-cell unit; b) recovering a dinitrogen-and dihydrogen-rich anode gas stream; c) cooling the anode gas stream and condensing the water present in the gaseous anode stream to form a cooled gaseous anode stream; d) separating the cooled gaseous anode stream into a dinitrogen gas stream; and a dinitrogen-depleted anode stream; and e) injecting the dinitrogen-depleted anode stream; into the fuel cell unit so as to recycle the dinitrogen-depleted anode stream in the fuel cell unit.

The present invention relates to a method for implementing an ammonia-burning fuel-cell system, the method comprising a step for recycling dihydrogen formed during the method that is not consumed in the fuel cell.

The method of the invention is typically implemented in a fuel-cell plant enabling the production of an electric current by electrochemical reaction between dihydrogen H₂ and dioxygen from the air. In the context of an ammonia-fueled fuel cell, the dihydrogen H₂ used as the fuel fluid is generated during cell operation by the decomposition of ammonia NH₃ at the fuel cell, in particular at the cell anode.

The fuel cell typically consists of one or more fuel cells, preferably operating at high temperature and enabling internal cracking of ammonia. Examples that may be cited include solid oxide fuel cells (SOFCs).

These batteries are currently designed mainly for stationary applications, with output power ranging from 1 kW to 2 MW.

An SOFC element is generally made up of four layers, three of which are ceramic. A single stack made up of these four superimposed layers is typically just a few millimeters thick. Dozens of these stacks are then superimposed in series to form a stack.

In these cells, oxygen ions formed on the cathode side are moved through a solid oxide used as a high-temperature electrolyte to react with the fuel gas, notably dihydrogen H₂, on the anode side.

This electrochemical reaction leads to the production of electricity, as well as the formation of water, the by-product of the electrochemical reaction. Dinitrogen, resulting from the decomposition of ammonia, is also recovered at the stack outlet, as a mixture with the water formed.

In order to prevent and/or limit damage to the electrochemical cells during their operation, in particular due to the potential differences to which they are subjected, the flow rates of fuel, in particular ammonia, and oxidant, in particular air, are adjusted so that the amount of dihydrogen H₂ in the cell always exceeds the maximum reaction capacity in the cell. As a result, a significant amount of unconsumed hydrogen is recovered from the SOFC element. The conversion rate of dihydrogen in a SOFC element is typically around 60%. In other words, around 40% of the hydrogen formed is recovered from the cell without having reacted with oxygen ions. Similarly, the air leaving the fuel cell is depleted in oxygen, but still contains a significant amount.

In known plants, the unconsumed dihydrogen is recovered at the stack outlet and then burned in a catalytic converter to be recovered in the form of thermal energy. One example is the method described in US 2021/0214849.

However, the use of dihydrogen by combustion is limited. In particular, it does not achieve electrical efficiencies as high as those theoretically permitted by the fuel cell. What's more, the operation of catalytic furnaces regularly leads to the formation of nitrogen oxides (also known as “NOx”), which can be difficult to manage. As nitrogen oxides are pollutants for the environment, adaptations to methods are necessary to prevent their release into the atmosphere.

US 2014/007889 describes a method for implementing an ammonia-fueled fuel-cell system wherein the anode output stream is fed into an aftertreatment unit wherein H₂-dihydrogen is separated from water and dinitrogen. The H₂-dihydrogen stream recovered in this way is then injected into the fuel cell for recycling. H₂-dihydrogen recovery is achieved by means of a series of hydrogen pumps enabling the recovery of a high-purity H₂-dihydrogen stream.

However, hydrogen pumps are expensive and bulky pieces of equipment. Their energy consumption is also high. In particular, the amount of energy required to pump the hydrogen is generally only slightly less than the amount of energy recovered by recycling the hydrogen. The energy gain associated with recycling dihydrogen using hydrogen pumps is negligible.

One aim of the invention is therefore to provide a method for implementing a fuel-cell system that enables the H₂-dihydrogen present in the anode effluent to be recovered efficiently and reliably for recycling at the cell inlet, in particular with the aim of increasing the overall energy performance of the method, while limiting the investment and operating costs of the method.

In particular, the aim of the invention is to provide an integrated method which, by minimizing the energy requirement for H₂-dihydrogen recovery, improves the overall energy performance of the electrical power generation unit.

Another aim of the invention is to provide a method for implementing an ammonia-burning fuel-cell system, the operation of which does not lead to the emission of nitrogen oxides (NOx) in the exhaust gas.

To this end, the invention relates to a method for implementing a fuel-cell system, comprising the following steps:
a) operating a fuel-cell unit comprising at least one anode system and at least one cathode system, said fuel-cell unit being continuously supplied with an ammonia-rich gas stream injected at the anode system and with a dioxygen-rich gas stream injected at the cathode system;
b) recovering a dinitrogen-and dihydrogen-rich anode gas stream and a cathode gas stream at the outlet of the fuel-cell unit;
c) cooling the anode gas stream and condensing the water present in the anode gas stream to form a cooled anode gas stream;
d) separating the cooled anode gas stream into a dinitrogen gas stream and a dinitrogen-depleted anode stream;
e) injecting at least part of the dinitrogen-depleted anode stream into the fuel-cell unit, in particular at the anode system, so as to recycle said at least part of the dinitrogen-depleted anode stream into the fuel-cell unit,
wherein the dinitrogen-depleted anode stream has a residual dinitrogen content greater than or equal to 5% by volume. The method according to the invention may comprise one or more of the following features, considered alone or according to any technically possible combination:
the dinitrogen-depleted anode stream has a dinitrogen content greater than 10% by volume, preferably greater than 20% by volume, more preferentially from 10% to 50% by volume, even more preferentially from 15% to 40% by volume, advantageously from 20 to 30% by volume;
said at least part of the dinitrogen-depleted anode stream is injected into the ammonia-rich gas stream to form an ammonia-rich feed stream, said feed stream then being injected into the fuel-cell unit, in particular at the anode system;
the feed stream has a dihydrogen content greater than or equal to 15% volume, preferably greater than or equal to 40% volume, more preferentially from 40% to 50% volume;
step d) of separating the cooled anode gas stream is carried out by membrane separation, pressure swing adsorption, temperature swing adsorption, or pressure-temperature swing adsorption;
the method comprises between steps c) and d) an intermediate step of compressing the cooled anode gas stream, preferably to a pressure greater than or equal to 10 bara, more preferentially greater than or equal to 20 bara, typically between 20 bara and 40 bara;
the anode gas stream is at least partially cooled in step c) by heat exchange with the ammonia-rich gas stream or feed stream;
the dioxygen-rich gas stream, before being introduced into the fuel-cell unit, is at least partially heated by heat exchange with the cathode gas stream;
the method does not comprise a step of burning the anode gas stream, not even one of partial burning.

The invention further relates to a fuel-cell plant comprising:
a fuel-cell unit comprising an inlet for introducing an ammonia-rich gas stream, an inlet for introducing a dioxygen-rich gas stream, an outlet for recovering an anode gas stream, and an outlet for recovering a cathode gas stream,
a cooling and condensing unit for cooling and drying the anode gas stream to form a cooled anode gas stream,
a separation unit for separating the cooled anode gas stream into a dinitrogen gas stream and a dinitrogen-depleted anode stream, said separation unit comprising a dinitrogen-depleted anode stream recovery outlet, said dinitrogen-depleted anode stream recovery outlet being connected to the inlet for introducing the ammonia-rich gas stream into the fuel-cell unit,
   wherein the separation unit comprises at least one separation module selected from the group consisting of: a membrane separation unit, a pressure swing adsorption unit, a temperature swing adsorption unit, a pressure-temperature swing adsorption unit and any combination thereof.

The plant according to the invention may comprise the feature that the separation unit further comprises a compression module, located upstream of said separation module.

The invention will be better described upon reading the following description, given solely by way of example, and made with reference to the accompanying drawing, wherein:

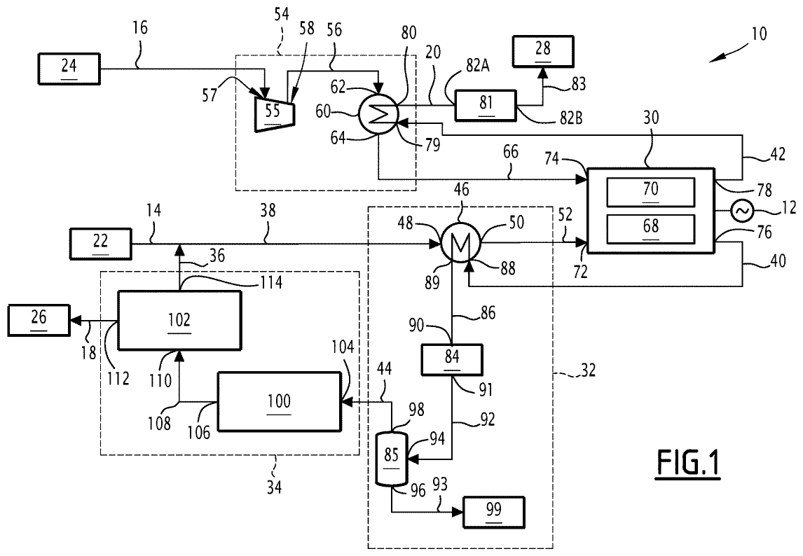

FIG. 1 is a block diagram showing a plant for implementing a method according to the invention.

A plant 10 according to the invention is illustrated schematically in FIG. 1.

The plant 10 is designed to generate an electric current 12 from an ammonia gas stream 14 and a dioxygen-rich gas stream 16.

The plant 10 is also designed to recover, as effluents, on the one hand a dinitrogen gas stream 18 and on the other hand a dioxygen-depleted gas stream 20.

The plant 10 is connected upstream to a first storage unit 22 for storing ammonia gas 14, and to a second storage unit 24 for storing dioxygen-rich gas 16.

Alternatively, the storage unit 22 can be replaced by a gas distribution network for feeding ammonia gas 14 into the plant 10 of the invention.

When the dioxygen-rich gas 16 is air, the storage unit 24 can be replaced by a system of pump(s) and compressor(s) for feeding atmospheric air, possibly compressed, into the plant 10 of the invention.

The ammonia gas stream 14 is predominantly made up of ammonia. Preferably, the ammonia gas stream 14 has an ammonia content greater than or equal to 90% by volume, more preferentially greater than or equal to 95% by volume, even more preferentially greater than or equal to 97% by volume, advantageously greater than or equal to 98% by volume, more advantageously greater than or equal to 99% by volume.

Preferably, ammonia gas 14 consists essentially of ammonia, and possibly impurities.

In one embodiment, the ammonia gas stream 14 may comprise very small quantities of impurities, in particular water and traces of oil.

Preferably, the ammonia gas stream 14 has an impurity content of less than or equal to 10% by volume, more preferentially less than or equal to 5% by volume, typically less than or equal to 1% by volume.

Preferably, the ammonia gas stream 14 is at a pressure ranging from 1 atm to 5 bara (absolute bar), more preferentially from 1 atm to 2 bara (absolute bar)

The dioxygen-rich gas stream 16 typically has a dioxygen content of at least 10% by volume, preferably 15% to 25% by volume of dioxygen. Advantageously, the dioxygen-rich gas stream 16 is an air stream.

Preferably, the dioxygen-rich gas stream 16 is at a pressure ranging from 1 atm to 5 bara (absolute bar).

The plant 10 is connected downstream to a plant 26 for collecting the dinitrogen gas stream 18, and to a plant 28 for collecting the dioxygen-depleted gas stream 20 for aftertreatment. Alternatively, the dinitrogen gas stream 18 and/or the dioxygen-depleted gas stream 20 are released directly into the atmosphere.

Preferably, the dioxygen-depleted gas stream 20 is discharged directly into the atmosphere at the plant 28.

Alternatively, the dioxygen-depleted gas stream 20 is collected in the plant 28 and routed to another plant for consumption or processing.

The plant 10 typically comprises a fuel-cell unit 30, a cooling and condensation unit 32, and a separation unit 34.

Prior to its introduction into the fuel-cell unit 30, the ammonia gas stream 14 is mixed with a recycling stream 36 recovered at the outlet of the separation unit 34 to form an ammonia-rich feed stream 38. The nature of recycling stream 36 is described in detail below.

The fuel-cell unit 30 is designed to produce the electric current 12 from the feed stream 38 and the dioxygen-rich gas stream 16 to form an anode gas stream 40 and a cathode gas stream 42.

The cooling and condensation unit 32 is designed to cool the anode gas stream 40 and extract at least some of the water by condensation to form a cooled anode gas stream 44.

Finally, the separation unit 34 is designed to recover at least some of the dinitrogen present in the cooled anode gas stream 44 in the form of the dinitrogen gas stream 18, and to recover a dinitrogen-depleted anode stream 36, also referred to as the recycling stream 36.

Preferably, the plant 10 according to the invention comprises, upstream of the fuel-cell unit 30, a first heat exchanger system 46 designed to heat the ammonia-rich feed stream 38 prior to its introduction into the fuel-cell unit 30.

For the purposes of this invention, a heat exchanger system comprises at least one heat exchanger. A heat exchanger system can thus comprise a single heat exchanger or a plurality of heat exchangers associated with each other.

The first heat exchanger system 46 thus comprises an inlet 48 for introducing the ammonia-rich feed stream 38 and an outlet 50 for recovering a heated fuel stream 52.

Preferably upstream of the fuel-cell unit, the plant 10 further comprises a unit 54 for pretreating the dioxygen-rich gas stream 16. The pretreatment unit 54 is designed on the one hand to compress and/or dry and/or filter, preferably compress, dry and filter, the dioxygen-rich gas stream 16, and on the other hand to heat the dioxygen-rich gas stream 16 prior to its introduction into the fuel-cell unit 30.

The pretreatment unit 54 firstly comprises a module 55 designed to compress and/or dry and/or filter, preferably compress, dry and filter, the dioxygen-rich gas stream 16 to form a pressurized dioxygen-rich gas stream 56. The module 55 thus comprises an inlet 57 for introducing dioxygen-rich gas stream 16 and an outlet 58 for recovering pressurized dioxygen-rich gas stream 56.

Preferably, the pretreatment unit 54 further comprises a second heat exchanger system 60 designed to heat the pressurized dioxygen-rich gas stream 56 prior to its introduction into the fuel-cell unit 30. The second heat exchanger system 60 thus comprises an inlet 62 for introducing the pressurized dioxygen-rich gas stream 56 and an outlet 64 for recovering a heated dioxygen-rich stream 66.

The fuel-cell unit 30 typically comprises at least one anode system 70 and at least one cathode system 72, separated from each other by at least one electrolyte (not shown), in particular a solid electrolyte.

For the purposes of this invention, an anode (or cathode) system comprises at least one anode (or cathode). An anode (or cathode) system can thus comprise a single anode (or cathode) or a plurality of anodes (or cathodes) associated with each other.

The fuel-cell unit 30 comprises an inlet 72 for introducing the heated fuel stream 52. The inlet 72 is designed to bring the heated fuel stream 52 into contact with the anode system 68.

The fuel-cell unit 30 further comprises an inlet 74 for introducing the heated dioxygen-rich stream 66. In particular, the inlet 74 is designed to bring the heated dioxygen-rich stream 66 into contact with the cathode system 70.

The fuel-cell unit 30 further comprises an outlet 76 for recovering the anode gas stream 40, which results from the operation of the fuel-cell unit 30 and is recovered from the anode system 68.

The fuel-cell unit 30 further comprises an outlet 78 for recovering a dioxygen-depleted cathode gas stream 42, which results from the operation of the fuel-cell unit 30 and recovered from the cathode system 70.

The outlet 78 for recovering the dioxygen-depleted cathode gas stream 42 is connected to the plant 28, preferably via the pretreatment unit 54.

In one embodiment, the outlet 78 is connected to the pretreatment unit 54, which in turn is connected to the plant 28, so that the dioxygen-depleted cathode gas stream 42 undergoes one or more aftertreatments before being transferred to the plant 28.

Preferably, the outlet 78 for recovering the cathode gas stream 42 is connected upstream of the plant 28 to the second heat exchanger system 60, so that the dioxygen-depleted cathode gas stream 42 is cooled there, by heat exchange with the pressurized dioxygen-rich gas stream 56, to form the dioxygen-depleted gas stream 20. The second heat exchanger system 60 then comprises an inlet 79 for introducing the cathode gas stream 42 and an outlet 80 for recovering the dioxygen-depleted gas stream 20.

In an even more preferred embodiment, the outlet 80 of the second heat exchanger system 60 is connected to a supplementary cooling system 81 designed to further cool the dioxygen-depleted gas stream 20, before transferring it to the plant 28. The supplementary cooling system 81 then comprises an inlet 82A for introducing the dioxygen-depleted gas stream 20 and an outlet 82B for recovering a cooled dioxygen-depleted gas stream 83. The outlet 82B of the supplementary cooling system 81 is directly connected to the plant 28.

The supplementary cooling system 81 may contain heat exchangers that enable the recovered heat to be used, for example, to supply a Rankine-type steam or electrical generation system, or a heat distribution network. Preferably, when there is no thermal integration for heat recovery, the supplementary cooling system 81 consists of coolers such as air coolers or water exchangers to achieve the required cooling level.

This method is advantageous in that it enables the dioxygen-rich gas stream 16 to be heated by thermal integration before being introduced into the fuel-cell unit 30, without the need for external energy input.

The cooling and condensation unit 32 typically comprises, on the one hand, a heat exchanger system 46 and a supplementary cooling module 84 designed to cool the anode gas stream 40 and at least partially condense the water present in the anode gas stream 40 resulting from the operation of the fuel-cell unit 30, and, on the other hand, a condensate recovery system 85.

In one embodiment, the outlet 76 for recovering the anode gas stream 40 is connected to the first heat exchanger system 46 so that the anode gas stream 40 is cooled there by heat exchange with the ammonia-rich feed stream 38, to form a pre-cooled anode stream 86. The first heat exchanger system 46 thus comprises an inlet 88 for introducing the anode gas stream 40 and an outlet 89 for recovering the pre-cooled anode stream 86.

Thus, according to this embodiment, the heat exchanger system of the cooling and condensation unit 32 is constituted by the first heat exchanger system 46 described above.

This method is advantageous in that it enables the feed stream 38 to be heated before being introduced into the fuel-cell unit 30, and to cool the anode gas stream 40 before being introduced into the condensate recovery system 85, by thermal integration without the need for external energy input.

In an alternative embodiment (not shown), the heat exchanger system of the cooling and condensation unit 32 is separate from the first heat exchanger system 46.

The supplementary cooling module 84 is designed to further cool the pre-cooled anode stream 86 exiting the first heat exchanger system 46 before it is introduced into the condensate recovery system 85. In particular, the supplementary cooling module 84 cools the water present in the pre-cooled anode stream 86 to a temperature low enough to allow condensation.

The supplementary cooling module 84 thus comprises an inlet 90 for introducing the pre-cooled anode stream 86 and an outlet 91 for recovering a cooled anode stream 92.

In a preferred embodiment, the supplementary cooling module 84 consists of a heat exchanger for recovering, preferably recovering and reusing, the heat from the pre-cooled anode stream 86. This heat is recovered, for example, by feeding a steam generation system, a Rankine-type electrical generation system, or a heat distribution network.

Preferably, the supplementary cooling module 84 comprises one or more coolers, in particular selected from air coolers, water exchangers and any combination thereof.

The condensate recovery system 85 is designed to condense the water present in the cooled anode stream 92 to form a liquid water condensate 93 at the bottom of the condensate recovery system 85, and the cooled anode gas stream 44 at the top of the condensate recovery system 85. The condensate recovery system 85 thus comprises an inlet 94 for introducing the cooled anode stream 92, an outlet 96 for recovering condensate 93, and an outlet 98 for recovering the cooled anode gas stream 44.

The plant 10 further comprises a system 99 for collecting liquid-water condensate 93.

The separation unit 34 typically comprises a compression unit 100 and a separation module 102.

The compression unit 100 is designed to at least partially compress the cooled anode gas stream 44 recovered at the outlet 98 of the cooling and condensation unit 32. The compressor unit 100 thus comprises an inlet 104 for introducing the cooled anode gas stream 44 and an outlet 106 for recovering a compressed cooled anode gas stream 108.

The nature of the compression unit 100 is not particularly limited. Any device known to the person skilled in the art that is capable of compressing the cooled anode gas stream 44 sufficiently for separation can be used. The compressor unit 100 consists, for example, of a series of compressors and/or blowers.

The separation module 102 is designed to partially extract the dinitrogen present in the compressed, cooled anode gas stream 108, so as to recover the dinitrogen gas stream 18 on the one hand, and the dinitrogen-depleted anode stream 36 (also known as the recycling stream 36) on the other. The separation module 102 thus comprises an inlet 110 for introducing the compressed, cooled anode gas stream 108, an outlet 112 for recovering the dinitrogen gas stream 18, and an outlet 114 for recovering the dinitrogen-depleted anode stream 36.

The separation module 102 is typically made up of any equipment known to the person skilled in the art and capable of at least partially extracting the dinitrogen present in a gaseous mixture of dihydrogen and dinitrogen.

The separation module 102 can optionally be supplemented by one or more additional items of equipment chosen from the group of: a purification unit (not shown) to remove any nitrogen oxides (NOx), a drying device and a superheater. When present, this additional equipment is typically placed upstream of the separation module 102, typically between the compression unit 100 and the separation module 102.

The separation module 102 typically comprises a membrane separation unit, a pressure-swing adsorption (PSA) unit, a temperature-swing adsorption (TSA) unit, a pressure-temperature-swing adsorption (PTSA) unit, or any combination thereof.

This equipment is well known to the person skilled in the art and will not be described further below.

Preferably, the outlet 112 for recovering the dinitrogen gas stream 18 is connected to the plant 26 so that the dinitrogen gas stream 18 can be collected there for aftertreatment.

Preferably, the outlet 114 for recovering the dinitrogen-depleted anode stream 36 is connected to the inlet 48 of the first heat exchanger system 46 for mixing with the ammonia gas stream 14.

According to a preferred embodiment, the plant 10 according to the invention does not comprise hydrogen pumps. Such equipment is expensive and bulky. They also require a significant amount of energy to operate, generally only slightly less than that recovered by recycling the hydrogen. The system according to the invention is therefore advantageous in that it dispenses with this costly, cumbersome, energy-intensive equipment.

The streams described in the plant are conflated with the pipes that carry them.

The implementation of a first method according to the invention will now be described.

The method according to the invention comprises firstly supplying at least one ammonia gas stream 14, from the plant 22 (or a gas pipe network), and at least one dioxygen-rich gas stream 16, from the plant 24.

The ammonia gas stream 14 is first mixed with the dinitrogen-depleted anode stream 36 (also known as the recycling stream 36) recovered at the outlet 114 of the separation unit 34 to form the ammonia-rich feed stream 38.

As explained in detail below, the hydrogen not consumed by the fuel-cell unit 30 is recovered and reinjected upstream of the fuel-cell unit 30 in the form of the dinitrogen-depleted anode stream 36 for recycling.

The ratio at which the ammonia gas stream 14 and the dinitrogen-depleted anode stream 36 are mixed depends on the conversion rate of the fuel-cell unit 30, which is typically 60%.

Preferably, the ammonia gas stream 14 and the dinitrogen-depleted anode stream 36 are mixed in a volume ratio ranging from 1:10 to 10:1, more preferentially from 5:10 to 1:1, advantageously from 1:2 to 4:5, typically 7:10.

Preferably, the ammonia-rich feed stream 38 has an ammonia NH₃ content of 15% to 75% by volume, more preferentially 30% to 60% by volume, advantageously 40% to 50% by volume, typically 45% by volume.

Preferably, the ammonia-rich feed stream 38 has a dihydrogen H₂content of 15% to 75% by volume, more preferentially 30% to 60% by volume, advantageously 40% to 50% by volume, typically 45% by volume.

Preferably, the ammonia-rich feed stream 38 has a dinitrogen N₂ content of 0% to 50% by volume, more preferentially 5% to 30% by volume, advantageously 10% to 20% by volume, typically 10% by volume.

The ammonia-rich feed stream 38 is then introduced into the first heat exchanger system 46, where it is heated to form a heated fuel stream 52.

Preferably, upstream of the first heat exchanger system 46, the ammonia-rich feed stream 38 has a temperature of 5° C. to 80° C., more preferentially 20° C. to 50° C., advantageously 30°° C. to 40° C., typically 35° C.

Preferably, the ammonia-rich feed stream 38 is heated at the first heat exchange system 46 to a temperature lower than the temperature of the fuel-cell unit 30, more preferentially to a temperature lower by 10° C. to 300° C. than that of the fuel-cell unit 30, more preferentially lower by 50° C. to 200° C., typically lower by 100° C. to 150° C.

The heated fuel stream 52 is then introduced into the fuel-cell unit 30.

At the same time, the dioxygen-rich gas stream 16 is introduced into the pretreatment unit 54, where it is compressed and/or dried and/or filtered, preferably compressed, dried, and filtered, and also heated before being introduced into the fuel-cell unit 30.

More particularly, the dioxygen-rich stream 16 is first introduced into the module 55 to be compressed and/or dried and/or filtered, preferably compressed, dried, and filtered, to form a pressurized dioxygen-rich gas stream 56 at the outlet.

The pressurized dioxygen-rich gas stream 56 is then introduced into the second heat exchanger system 60, where it is heated to form the heated dioxygen-rich stream 66 at the outlet 64.

Preferably, upstream of the second heat exchanger system 60, the dioxygen-rich pressurized gas stream 56 has a temperature of 10° C. to 200° C., more preferentially 50° C. to 150° C., typically 75° C. to 120° C., typically 90° C. to 95° C.

Preferably, the dioxygen-rich pressurized gas stream 56 is heated at the second heat exchange system 60 to a temperature lower than that of the fuel-cell unit 30, more preferentially to a temperature lower by 10° C. to 300° C. than the temperature of the fuel-cell unit 30, more preferentially lower by 50° C. to 200° C., typically lower by 100° C. to 150° C.

The heated dioxygen-rich stream 66 is then introduced into the fuel-cell unit 30.

The dioxygen-rich stream 16 and the feed stream 38 are pre-heated to maintain a relatively constant temperature inside the stack unit 30 and thus guarantee optimum performance.

The fuel-cell unit 30, continuously supplied with the heated fuel stream 52 and the heated dioxygen-rich stream 66, is then put into operation.

To do this, the heated fuel stream 52 is introduced into the fuel-cell unit 30 at the inlet 72. In particular, the heated fuel stream 52 is injected into the anode system 68.

The heated dioxygen-rich stream 66 is introduced into the inlet 74 of the fuel-cell unit 30. In particular, the heated dioxygen-rich stream 66 is injected into the cathode system 70.

On entering the fuel-cell unit 30, the heated fuel stream 52 undergoes a first catalytic cracking step, during which the ammonia present in the heated fuel stream 52 decomposes into dinitrogen gas N₂ and hydrogen gas H₂. The catalytic cracking of ammonia is initiated by the high temperature inside the fuel-cell unit 30 in the presence of the catalytic materials in the anode system 68. The temperature inside the fuel-cell unit 30 during operation depends on the type of high-temperature fuel cell and the operating choices made. In the case of an SOFC fuel cell, this is typically 500° C. to 1100° C., preferably 700° C. to 900° C.

Preferably, all the ammonia in the heated fuel stream 52 is decomposed into dinitrogen gas N₂ and hydrogen gas H₂ at the fuel-cell unit (30).

On contact with the anode system 68, H₂ hydrogen dissociates into H⁺ protons and electrons. The electrons thus released accumulate at the anode system 68 and are transferred to the cathode system 70 of the fuel-cell unit 30 by means of an external circuit, the movement of electrons from the anode system 68 to the cathode system 70 generating the electric current 12.

The dinitrogen N₂ present in the fuel-cell unit 30, particularly in the anode system 68, is inert at the operating temperatures of the fuel-cell unit 30. In particular, the nitrous oxide N₂ is not oxidized and ends up entirely in the anode gas stream 40 recovered at the outlet of the fuel-cell unit 30.

In the cathode system 70, the electrons carried by the electric current 12 are fixed by the dioxygen O₂ present in the heated dioxygen-rich stream 66. The dioxygen molecules O₂ are then transformed into superoxide ions O₂₋ by the capture of two electrons.

The superoxide ions O₂₋ thus formed then pass through the electrolyte to the anode system 68, where they react with the protons H⁺ generated earlier to form water H₂O.

The anode gas stream 40 and the cathode gas stream 42 are then recovered at the outlet of the fuel-cell unit 30.

The cathode gas stream 42, corresponding to the residual gas stream recovered at the outlet of cathode system 70, is recovered at the outlet 78 of the fuel-cell unit 30. The stream 42 has a reduced dioxygen content compared to the initial heated dioxygen-rich stream 66.

Typically, the cathode gas stream 42 has a dioxygen content of less than or equal to 20% by mole, preferably from 5% to 15% by mole.

The cathode gas stream 42 is then conveyed to the plant 28.

In one embodiment, before reaching the plant 28, the cathode gas stream 42 is cooled by passing through the second heat exchanger system 60. In this way, the cathode gas stream 42 is cooled by heat exchange with the pressurized dioxygen-rich gas stream 56 to form the dioxygen-depleted gas stream 20.

The cathode gas stream 42 recovered at the outlet 78 of the fuel-cell unit 30 has a temperature close to the temperature of the fuel-cell unit 30.

Thus, in the case of an SOFC fuel cell, the cathode gas stream 42 recovered at the outlet 78 of the fuel-cell unit 30 typically has a temperature of 500° C. to 1100° C., preferably 700° C. to 900° C.

Preferably, the cathode gas stream 42 is cooled to a temperature ranging from 50° C. to 250° C., preferably from 100° C. to 200° C.

This method is advantageous in that it enables the dioxygen-rich gas stream 16 at the inlet to be heated, and the cathode gas stream 42 at the outlet to be cooled, by thermal integration without the need for external energy input.

According to an even more preferred method, the cathode gas stream 42 is cooled in at least two stages before being transferred to the plant 28. In particular, the cathode gas stream 42 is first cooled in the second heat exchanger system 60 to an intermediate temperature of 200° C. to 350° C., preferably 250° C. to 300° C. Then, the dioxygen-depleted stream 20 recovered at the outlet 80 of the second heat exchanger system 60 is transferred to a supplementary cooling system 81 for further cooling of the cathode gas stream 42 to a temperature compatible with the characteristics of the plant 28 for collecting the dioxygen-depleted stream 20. The cooled, dioxygen-depleted gas stream 83 recovered at the outlet 82B of the supplementary cooling system 81 typically has a temperature below 200° C., preferably between 100° C. and 200° C., advantageously around 150° C. This supplementary cooling system 81 may contain heat exchangers enabling the recovered heat to be valorized by feeding, for example, a Rankine-type steam or electrical generation system, or a heat distribution network. Preferably, the supplementary cooling system 81 consists of coolers such as air coolers or water exchangers to achieve the required cooling level

The anode gas stream 40, corresponding to the residual gas stream recovered at the outlet of the anode system 68, is recovered at the outlet 76 of the fuel-cell unit 30. The anode gas stream 40 is made up of a mixture of water H₂O resulting from the operation of the fuel-cell unit 30, as well as unreacted dinitrogen N₂ and dihydrogen H₂.

Preferably, at most 40% by volume of the dihydrogen H₂ formed by ammonia decomposition inside the fuel-cell unit 30 is recovered in the anode gas stream 40, more preferentially from 20% to 30% by volume.

Preferably, the anode gas stream 40 has a dinitrogen content of 10% to 40% by volume, more advantageously 20% to 30% by volume, typically 25% by volume.

Preferably, the anode gas stream 40 has a water H₂O content of 30% to 60% by volume, more preferentially 40% to 50% by volume, typically 45% by volume.

In the case of an SOFC fuel cell, the anode gas stream 40 recovered at the outlet 76 of the fuel-cell unit 30 typically has a temperature of 500° C. to 1100° C., typically 700° C. to 900° C.

The entire anode gas stream 40 is then introduced into the cooling and condensation unit 32, where it is cooled and at least some, preferably most, of the water formed is removed.

The anode gas stream 40 is first cooled by passing through one or more heat exchanger systems.

Preferably, the anode gas stream 40 is first introduced into the first heat exchanger system 46, where it is cooled by heat exchange with the ammonia-rich feed stream 38. A pre-cooled anode stream 86 is recovered at the outlet 89 of the first heat exchanger system 46.

In the case of an SOFC fuel cell, the anode gas stream 40 recovered at the outlet 76 of the fuel-cell unit 30 typically has a temperature of 500° C. to 1100° C., preferably 700° C. to 900° C.

Preferably, the anode gas stream 40 is cooled in the first heat exchanger system 46 to a temperature of 300° C. to 500° C., preferably 350° C. to 450° C.

Preferably, the pre-cooled anode stream 86 is then introduced into the supplementary cooling module 84 for further cooling. A cooled anode stream 92 is recovered from the outlet 91 of the supplementary cooling module 84.

Preferably, the pre-cooled anode stream 86 is cooled in the supplementary cooling module 84 to a temperature of 100° C. or less, more preferentially between 10° C. and 50° C., typically between 30° C. and 40° C.

The cooled anode stream 92 is then introduced into the condensate recovery system 85 to remove the water present in the cooled anode stream 92.

In particular, the cooled anode stream 92 is introduced into the condensate recovery system 85. A liquid water condensate 93 is collected at the bottom of the condensate recovery system 85, while the cooled anode gas stream 44 is collected at the top of the condensate recovery system 85.

The condensate 93 is then sent to plant 99 for aftertreatment.

Preferably, if the fuel-cell system is operates at near-atmospheric pressure, the cooled anode gas stream 44 has a water content of less than or equal to 10% by volume, more preferentially less than or equal to 6% by volume.

The entire cooled anode gas stream 44 is then injected into the separation unit 34, where it is split into the dinitrogen gas stream 18 and the dinitrogen-depleted anode stream 36, also known as the recycling stream 36.

Preferably, the cooled anode gas stream 44 undergoes a preliminary compression step. To achieve this, the cooled anode gas stream 44 is fed into the compressor unit 100 to form the compressed cooled anode gas stream 108.

Preferably, if the fuel-cell system is operated at near-atmospheric pressure, the cooled anode gas stream 44 has a pressure of 0.7 bara to 2 bara (bar absolute), more preferentially 1 bara to 1.5 bara (bar absolute).

Preferably, the cooled, anode gas stream 44 is compressed in the compressor unit 100 to a pressure ranging from 10 bara to 100 bara (bar absolute), more preferentially from 20 bara to 40 bara (bar absolute). The final pressure of the cooled gas stream 44 depends on the characteristics of the separation module 102

The compressed, cooled anode gas stream 108 is then introduced into the separation module 102 to form the dinitrogen gas stream 18 on the one hand, and the dinitrogen-depleted anode stream 36 (recycling stream 36) on the other.

The dinitrogen gas stream 18 is then sent to the plant 26 for aftertreatment.

Preferably, the dinitrogen gas stream 18 consists essentially of ammonia, and possibly impurities.

More preferentially, the dinitrogen gas stream 18 has a dinitrogen content greater than or equal to 99.00% by volume, more preferentially between 99.90% and 99.99% by volume.

In one embodiment, the dinitrogen gas stream 18 may comprise very small quantities of impurities.

Impurities that may be present in the dinitrogen gas stream 18 include dihydrogen, ammonia, water, nitrogen oxides (or NOx) and traces of oil. The presence of a purification and/or drying unit, particularly upstream of the separation unit 102, reduces the impurity content.

Preferably, the dinitrogen gas stream 18 has an impurity content of less than or equal to 10% by volume, more preferentially less than or equal to 5% by volume, typically less than or equal to 1% by volume.

Preferably, the dinitrogen-depleted anode stream 36 (recycling stream 36) has a dihydrogen H₂ content greater than or equal to 50% by volume, more preferentially greater than or equal to 70% by volume, typically between 70% and 90% by volume, for example between 70% and 80% by volume.

Preferably, the dinitrogen-depleted anode stream 36 (recycling stream 36) has a residual dinitrogen N₂ content greater than or equal to 10% by volume, more preferentially greater than or equal to 20% by volume, typically between 20% and 40% by volume, for example between 20% and 30% by volume.

Finally, the dinitrogen-depleted anode stream 36 is injected into the ammonia gas stream 14, where it is recycled to the fuel-cell unit.

According to a preferred embodiment, the method according to the invention does not comprise the step of using one or more hydrogen pumps. The method according to the invention is thus advantageous in that it eliminates the need for hydrogen pumps.

The plant 10 and the method according to the invention thus enable the production of an electric current 12 by means of a fuel-cell unit 30 supplied with ammonia. In addition, the plant 10 and the method described herein enable unreacted dihydrogen to be recycled back into the fuel cell.

The invention is based on the fact that the residual presence of dinitrogen N₂ in the recycling stream 36 has little or no effect on the operation of the fuel-cell unit 30. Dinitrogen N₂ is a neutral gas for the fuel-cell unit 30. At the operating temperatures of the fuel-cell unit 30, the dinitrogen is inert and does not take part in any reaction that may occur inside the fuel-cell unit 30. However, too much nitrogen in the fuel cell can reduce fuel cell performance by diluting the dihydrogen fuel too much when it comes into contact with the anode system 68. The separation performance of the separation unit 102 enables a stream 36 to be generated whose stoichiometric proportions are as close as possible to the hydrogen/dinitrogen stoichiometry of the ammonia gas stream 14, once its decomposition has taken place within anode system 68. In this way, the feed stream 38 resulting from the mixture of ammonia gas stream 14 and dinitrogen-depleted recycled stream 36 is characterized by a hydrogen-nitrogen ratio very close to that of the ammonia gas stream 14. In fact, the electrochemical performance of the fuel-cell system 30 is not affected by this recycling 36.

In addition, the plant 10 and the method according to the invention significantly reduce the energy requirement associated with recycling dihydrogen H₂ by allowing a significant proportion of the dinitrogen N₂ recovered at the outlet of the fuel-cell unit 30 to be injected into the feed stream 38.

In methods of the prior art, the recycling stream is essentially dihydrogen H₂. In particular, all the dinitrogen present in the anode gas stream has been separated so that the recycling stream is virtually dinitrogen-free. Separation and purification steps requiring more specific separation equipment and/or a high energy requirement are then necessary to achieve the required purity.

In the context of the invention, the residual presence of dinitrogen in the recycling stream 36 means that less complex separation equipment can be used. The lower degree of purity allowed by the method of the invention also makes it possible to significantly reduce the energy requirements associated with the aftertreatment of the anode gas stream 40 prior to its recycling.

A further advantage of the method and system is that excess heat emitted by the fuel-cell unit can be recovered and recycled. In particular, the anode gas stream 40 recovered at the outlet 76 of the fuel-cell unit 30 is cooled in at least two stages, on the one hand by the first heat exchanger system 46, and on the other by the supplementary cooling module 84. The first heat exchanger system 46 cools the anode gas stream 40 by heat exchange with the ammonia-rich feed stream 38 to an intermediate temperature of 200° C. to 500° C., preferably 300° C. to 450° C. Then, the supplementary cooling module 84 cools the pre-cooled anode gas stream 86 leaving the first heat exchanger system 46. The supplementary cooling module 84 typically consists of a heat exchanger for recovering, preferably recovering and reusing, the heat from the pre-cooled anode stream 86. This heat is recovered, for example, by feeding a steam generation system, a Rankine-type electrical generation system, or a heat distribution network.

When the separation module 102 comprises a membrane separation unit (as described above), it is possible that the dinitrogen gas stream 18 recovered at the outlet of the module 102 is under pressure. Preferably, in this case, the plant 10 according to the invention comprises, between the separation module 102 and the plant 26, a complementary system of turbines designed to generate a complementary electric current by expansion of the pressurized dinitrogen gas stream 18.

The method and plant according to the invention are also advantageous in that they enable at least 80% of the dihydrogen formed by decomposition of ammonia to be consumed in the fuel-cell unit 30, preferably at least 90%, more preferentially at least 95%, typically at least 99% and advantageously all of the dihydrogen formed by decomposition of ammonia.

Last but not least, the system and method described in this invention are also advantageous in that they enable fuel that has not been consumed in the fuel-cell unit to be efficiently recycled.

1. A method for implementing a fuel-cell system, comprising the following steps:
a) operating a fuel-cell unit comprising at least one anode system and at least one cathode system, said fuel-cell unit being continuously supplied with an ammonia-rich gas stream injected at the anode system and with a dioxygen-rich gas stream injected at the cathode system;
b) recovering a dinitrogen-and dihydrogen-rich anode gas stream and a cathode gas stream at the outlet of the fuel-cell unit;
c) cooling the anode gas stream and condensing the water present in the anode gas stream to form a cooled anode gas stream;
d) separating the cooled anode gas stream into a dinitrogen gas stream and a dinitrogen-depleted anode stream;
e) injecting at least part of the dinitrogen-depleted anode stream into the fuel-cell unit, in particular at the anode system, so as to recycle said at least part of the dinitrogen-depleted anode stream-into the fuel-cell unit,
wherein the dinitrogen-depleted anode stream has a residual dinitrogen content greater than or equal to 5% by volume.

2. The method according to claim 1, wherein the dinitrogen-depleted anode stream has a dinitrogen content greater than 10% by volume, preferably greater than 20% by volume, more preferentially from 10% to 50% by volume, even more preferentially from 15% to 40% by volume, advantageously from 20 to 30% by volume.

3. The method according to claim 1, wherein said at least part of the dinitrogen-depleted anode stream is injected into the ammonia-rich gas stream to form an ammonia-rich feed stream, said feed stream then being injected into the fuel-cell unit, in particular at the anode system

4. The method according to claim 3, wherein the feed stream has a dihydrogen content greater than or equal to 15% volume, preferably greater than or equal to 40% volume, more preferentially from 40% to 50% volume.

5. The method according to claim 1, wherein step d) of separating the cooled anode gas stream is carried out by membrane separation, pressure swing adsorption, temperature swing adsorption, or pressure-temperature swing adsorption.

6. The method according to claim 5 further comprising between the steps c) and d) an intermediate step of compressing the cooled anode gas stream, preferably to a pressure greater than or equal to 10 bara, more preferentially greater than or equal to 20 bara, typically between 20 bara and 40 bara.

7. The method according to claim 1, wherein the anode gas stream is at least partially cooled in step c) by heat exchange with the ammonia-rich gas stream or feed stream.

7. The method according to claim 1, wherein the dioxygen-rich gas stream, before being introduced into the fuel-cell unit, is heated at least partially by heat exchange with the cathode gas stream.

9. The method according to claim 1, wherein it does not comprise a step of burning the anode gas stream, not even one of partial burning.

10. A fuel-cell plant comprising:
a fuel-cell unit comprising an inlet for introducing an ammonia-rich gas stream, an inlet for introducing a dioxygen-rich gas stream, an outlet for recovering an anode gas stream, and an outlet for recovering a cathode gas stream,
a cooling and condensing unit for cooling and drying the anode gas stream to form a cooled anode gas stream,
a separation unit for separating the cooled anode gas stream into a dinitrogen gas stream and a dinitrogen-depleted anode stream, said separation unit comprising a recovery outlet, said dinitrogen-depleted anode stream recovery outlet for recovering the dinitrogen-depleted anode stream being connected to the inlet for introducing the ammonia-rich gas stream into the fuel-cell unit,
wherein the separation unit comprises at least one separation module selected from the group consisting of: a membrane separation unit, a pressure swing adsorption unit, a temperature swing adsorption unit, a pressure-temperature swing adsorption unit and any combination thereof.

11. The plant according to claim 10, wherein the separation unit further comprises a compression module, located upstream of said separation module.
